(19) United States
(12) Patent Application Publication
(10) Pub. No.: US 2014/0202880 A1
(43) Pub. Date: Jul. 24, 2014

(54) SEGMENTED ELECTRODES FOR WATER DESALINATION

(71) Applicants: The Board of Trustees of the Leland Stamford Junior University, Palo Alto, CA (US); Lawrence Livermore National Security, LLC, Livermore, CA (US)

(72) Inventors: Matthew E. Suss, Cambridge, MA (US); Andrew J. Pascall, Livermore, CA (US); Christopher Spadaccini, Oakland, CA (US); Michael Stadermann, Pleasanton, CA (US); Juan G. Santiago, Stanford, CA (US)

(21) Appl. No.: 14/223,192

(22) Filed: Mar. 24, 2014

Related U.S. Application Data
(63) Continuation-in-part of application No. 13/405,088, filed on Feb. 24, 2012.
(60) Provisional application No. 61/480,752, filed on Apr. 29, 2011.

(51) Int. Cl. C02F 1/469

(52) U.S. Cl. CPC C02F 1/4691
USPC 205/758; 204/674

(57) ABSTRACT

Apparatus, systems, and methods for capacitive desalination using segmented electrodes in a flow-through or flow-between configuration. The segmented electrodes constitute layered stack electrode units. Each electrode includes pores into which the target salt water flows. An electrical circuit energizes the electrodes and produces an electrical field acting on the target salt water producing desalted water. The segmented electrodes provide ultra-thin cells into a robust framework necessary for desalination applications which yield orders of magnitude faster desalination.

### CROSS-REFERENCE TO RELATED APPLICATIONS

This application is a Continuation-in-Part of pending U.S. patent application Ser. No. 13/405,088 filed Feb. 24, 2012 titled, “Flow-Through Electrode Capacitive Desalination,” which is incorporated herein by this reference. U.S. patent application Ser. No. 13/405,088 filed Feb. 24, 2012 claimed benefit under 35 U.S.C. 119(e) of U.S. Provisional Patent Application No. 61/480,752 filed Apr. 29, 2011 entitled “flow-through electrode capacitive desalination.” This claim is also asserted in this application and the disclosure of U.S. Provisional Patent Application No. 61/480,752 filed Apr. 29, 2011 is hereby incorporated herein by reference.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory. This invention was made with Government support under contracts 0967600 awarded by the National Science Foundation and DE-AC52-07NA27344 awarded by the Department of Energy to Stanford University. The Government has certain rights in this application.

### BACKGROUND

1. Field of Endeavor

The present application relates to water desalination and more particularly to segmented electrodes for water desalination.

2. State of Technology

State of technology information is provided in United States Published Patent Application No. 2011/0247937 for a method and apparatus for permeating flow desalination. The Published Patent Application No. 2011/0247937 includes the following state of technology information:

Desalination refers to any process that removes dissolved minerals (including but not limited to salt) from seawater, brackish water, or treated wastewater to obtain fresh water for human consumption, irrigation or other industrial applications. Desalination of seawater is common in regions of water scarcity such as the Middle-East, and the Caribbean islands. In other parts of the world, such as the United States, North Africa, Singapore and China, desalination is mostly restricted to brackish water treatment. Desalination is also extensively used in ships, submarines, islands and homes in rural areas where freshwater distribution systems are insufficient to meet the daily needs. The latter also extends to countries where severe lack of infrastructure causes acute water shortfalls despite ample amount of precipitation.

The growing water crisis ranks alongside the problems of shortage of viable energy resources and global warming in terms of its frightening global spread and magnitude. The World Water Development Report by the United Nations delivers the grim prognosis that by the middle of this century, more than 50 nations, constituting a population between 2 to 7 billion, will face a water crisis. Currently, about 7500 desalination plants world-wide already strive to meet current water demands. However, their cumulative contribution is only about 1% of the world's water use. In other words, although the requirement for desalination has been well documented for the past several decades, desalination provides only a tiny fraction of the world's current freshwater needs. The contribution by desalination is so miniscule because the current state of the desalination technology does not support extensive use. One of the primary reasons for this deficiency is the cost. The prohibitive costs associated with the currently-prevailing membrane-based and thermal desalination technologies heavily discourages potential users, unless the local distribution of energy and water resources is significantly skewed in favor of the former, as in the Middle-East. Although membrane related research has helped improve the situation somewhat, particularly for potable water, the greater share of the market, for industrial and agricultural uses, cannot be satisfied with the energy requirements inherent in the processes. The large-scale desalination market is dominated by reverse osmosis (RO), a membrane-based process, and multi-stage flash (MSF), a distillation process. Another process that has been in vogue, since the 1970s, especially for brackish water desalination, is electrodialysis reversal (EDR), a membrane-based process.

In recent years, capacitive deionization (CDI) has been proposed as a solution to some of the crucial issues that have plagued the previous desalination processes, such as energy cost and membrane fouling. The CDI process involves the flow of saline water through, that is between, a pair of high surface area, porous electrodes (e.g. activated carbon cloth) across which a small voltage is applied. During the flow, the ions in the saline water move towards respective electrodes, depending upon the polarity of the ions. Each electrode is able to electrostatically adsorb the ions in a reversible manner. During this charging process, capacitive current flows in the external circuit connecting the electrodes. Consequently, the water flowing out of the system is de-ionized. Once the capacitor, formed by the electrodes, external circuit, and water, is fully charged, the ions are regenerated by shorting the electrodes (or by applying a reverse polarity), thereby flushing the ions absorbed during the charging process by means of waste water through the same flow path. This process is herein referred to as an axial flow discharge process (AFD). The CDI process has been reported to provide nearly an order of magnitude advantage in power requirements over the membrane processes and even the EOR process. This is supported, for example, by tables 2 and 3 of, “Effect of Permation on Discharge Characteristics of Capacitive Deionization Process” by Islum Barman, submitted to the department of mechanical engineering in partial fulfillment of the requirements or the degree of master of science in mechanical engineering at the Massachusetts Institute of Technology, June 2007, which is hereby incorporated by reference in its entirety.

Although the capacitive process has shown some promise, it is yet to be fully implemented in an industrial setup. The most significant obstacle to full-scale implementation of capacitive deionization systems is the low water recovery ratio characteristic of existing CDI systems. Water recovery ratio is defined as the amount of desalinated water obtained to the total amount of input water. For a given throughput of a desalination plant/process, the water recovery ratio and the power consumption per unit volume of water desalinated provide the two most significant metrics for judging the effectiveness of the plant/process. The power consumption of a desalination process, and attendant cost, is dependent upon, among other factors, the process water recovery. The costs of pumping and pre- and post-treatment of water, which are greater for low water recovery ratio processes, added to the rising costs of surface water, makes maximizing the recovery ratio .alpha. priority. Additionally, because aquifer withdrawals typically surpass aquifer recharge, with resulting drops in water tables, the maximization of water recovery ratio is even more important. In a conventional capacitive deionization process, the discharge typically takes at least half the time required for charging. This has led to typically poor water recovery ratios with the maximum reported being around 0.5-0.6 (for brackish water desalination), as disclosed, for example, in Capacitive Desalination Technology An Alternative Desalination Solution,” Desalination, 183, 2-340, 2005, Welgemoed, T. J. Schutte, C. F., and “Desalination Of A Thermal Power Plant Wastewater By Membrane Capacitive Deionization,” Desalination 196, 125-134, 2006, Lee, J-B., Park K-K, Eum, Lee, C-W., which are hereby incorporated by reference in their entirety. By way of comparison, the corresponding recovery ratios for the reverse osmosis and electrodialysis reversal processes for brackish water desalination typically exceed 0,85-0,94. See, for example, “High Water Recovery With Electrodialysis Reversal,” Proceedings American Water Works Association Membrane Conference, Baltimore, Md., Aug. 1-4 1993, by Allison, R. P., which is hereby incorporated by reference in its entirety. In addition, the available energy during a conventional capacitive deionization process cycle is not fully utilized, because the system is really operational in two-thirds of the total cycle time one third of the time the system is recharging by flushing accumulated ions from the system's electrodes. Consequently, expensive energy capacity is wasted in a conventional capacitive deionization process. Furthermore, the low water recovery ratio associated with a conventional capacitive deionization process constrains the range of salinity of input water the process can be used for.

Capacitive deionization involves a process whereby water from which ions are to be removed (referred to hereinafter as “feed water”) flows between electrodes to which a potential difference is applied. As the feed water flows between the electrodes, ions within the water are attracted to respective electrodes: negative ions to the positively charged electrode and positive ions to the negatively charged electrode. More ions are removed from the water as it traverses the path between the electrodes, rendering the water purer and purer along the path. At some point, the electrodes between which the water passes become saturated with ions that have been removed from the feed water and adhere to the electrodes. When the electrodes are saturated, the ions adhering to the electrodes are flushed, thereby producing some water with a much higher concentration of ions. The deionized, or “purified,” water and brackish, or “concentrated,” water are separated; the purified water destined for use in any of a myriad of applications, including agricultural, drinking, industrial, the concentrated water for disposal. Some components of the concentrated water, such as Sodium salt, may find application as well. Additionally, the components of concentrated water may contain precious metals which could be of further use in different applications. This method could thus be employed not only for desalinating brackish or sea water but also for purifying useful metals and such like.

The point at which the electrodes are flushed may be predetermined, on the basis of a time cycle, for example, or ion concentrations may be sensed and used by a controller to determine the time at which to begin and end an electrode-flushing process. In accordance with the principles of the present invention, solvent drag is employed to accelerate the flushing process and to thereby reduce the percentage of time devoted to recharging the system. A smaller percentage of time devoted to recharging the system yields a higher water recovery ratio, a key consideration in desalination systems.

In an illustrative embodiment, feed water is introduced to a channel with electrodes on either side. In this embodiment, the electrodes include a high specific surface area material. Examples of suitable materials include inert carbon-based solids such as an aerogel, porous woven carbon fiber electrodes, nanotubes or other nanostructure. During the desalination process the electrodes will be charged to attract ions to the electrodes. The ions are adsorbed by the high specific surface area material and, eventually, the electrodes become less and less effective at removing ions from the feed water. At a chosen time, which may be predetermined, based upon a predetermined cycle time, or which may be determined by sensing the ion concentration of water purified by the system, the electrodes are recharged using a combination of mechanisms including diffusion and solvent drag. Solvent drag provides for much more effective recharging of the electrodes than conventional diffusion-based recharging.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Applicant's apparatus, systems, and methods provide a capacitive desalination system using segmented electrodes in a flow-through configuration and in a flow-between configuration. Applicant's apparatus, systems, and methods utilize individual segmented electrodes having multiple layered cells. Each individual electrode contains a multiplicity of individual pores. The target salt water flows into the pores. An electrical circuit energizes the electrodes and produces an electrical field acting on the target salt water producing desalted water. Applicant's apparatus, systems, and methods combine complete, ultra-thin cells into a robust framework necessary for desalination applications which yield orders of magnitude faster desalination.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 illustrates a prior art system wherein a first monolithic electrode and a second monolithic electrode produce an electrical field acting on feed water in a gap between the electrodes and provide desalting of the water.

FIG. 2 illustrates a desalination system using segmented electrodes in a flow-through configuration.

FIG. 3 illustrates another embodiment of a desalination system using segmented electrodes.

FIG. 4 illustrates a desalination system using segmented electrodes in a flow-between configuration.

FIG. 5 illustrates another embodiment of a desalination system using segmented electrodes in a flow-between configuration.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

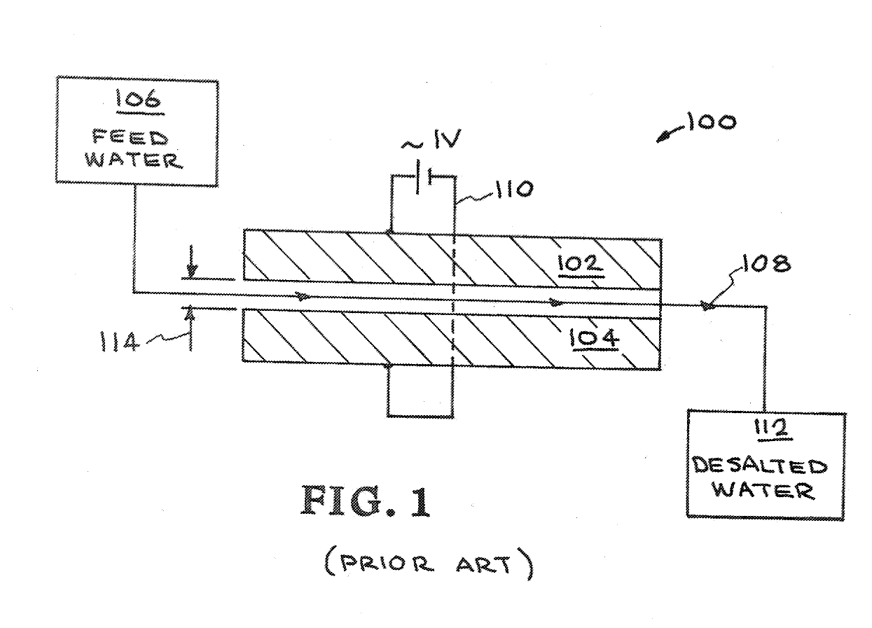

Referring now to the drawings and in particular to FIG. 1, a prior art system 100 is illustrated. In the prior art system 100 a first monolithic electrode 102 and a second monolithic electrode 104 are positioned adjacent but separated from each other forming gap 114. Feed water from a feed water source 106 is directed through the gap 114 between the first monolithic electrode 102 and the second monolithic electrode 104. A permeable separator layer can be positioned in the gap 114 between the electrodes 102 and 104 to prevent electrical shorts between the electrodes.

An electrical circuit 110 energizes the first monolithic electrode 102 and the second monolithic electrode 104 producing an electrical field acting on the feed water in the gap 114 between the first monolithic electrode 102 and the second monolithic electrode 104. As illustrated in FIG. 1, the flow 108 of feed water enters the gap 114 and travels in a direction perpendicular to the applied electric field. The flow 108 of feed water 106 in the gap 114 is illustrated by the arrow 108. The feed water is directed from feed water source 106 into the gap 114 where the electrical field provides desalting and into the desalted water unit 112.

The system 100 is a capacitive deionization system. In the capacitive deionization system 100 ions are to be removed (referred to hereinafter as “feed water”) flows between the first monolithic electrode 102 and the second monolithic electrode 104 to which a potential difference is applied by the electrical circuit 110. As the feed water flows through the gap 114 between the first monolithic electrode 102 and the second monolithic electrode 104, ions within the water are attracted to respective electrodes: negative ions to the positively charged electrode and positive ions to the negatively charged electrode. More ions are removed from the water as it traverses the path between the first monolithic electrode 102 and the second monolithic electrode 104, rendering the water purer and purer along the path. At some point, the first monolithic electrode 102 and the second monolithic electrode 104 between which the water passes become saturated with ions that have been removed from the feed water and adhere to the electrodes. When the first monolithic electrode 102 and the second monolithic electrode 104 are saturated, the ions adhering to the first monolithic electrode 102 and the second monolithic electrode 104 are flushed, thereby producing some water with a much higher concentration of ions. The deionized, or “purified,” water and brackish, or “concentrated,” water are separated; the purified water destined for use in any of a myriad of applications, including agricultural, drinking, industrial, the concentrated water for disposal.

This process is also capable of simultaneously removing a variety of other impurities. For example, dissolved heavy metals and suspended colloids can be removed by electrodeposition and electrophoresis, respectively. Capacitive deionization has several potential advantages over other more conventional technologies. Unlike ion exchange, no acids, bases,—or salt solutions are required for regeneration of the system. Regeneration is accomplished by electrically discharging the cell. Additional details of the capacitive deionization system 100 are provided in the publication, “Capacitive deionization of NaCl and NaNO3 solutions with carbon aerogels,” Farmer et at, J. Electrochem. Soc, 143, 1 (1996); also presented at the 27th International Society for the Advancement of Materials Process Engineers Technical Conference, Albuquerque, N. Mex., Oct. 9-42, 1995, which is incorporated herein in its entirety by this reference.

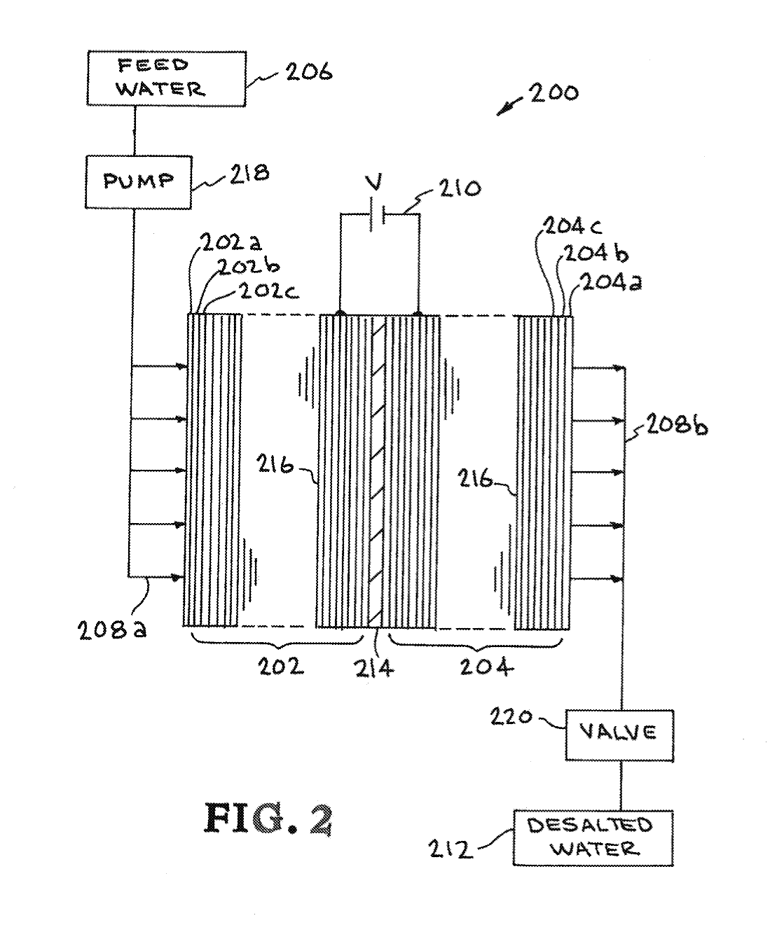

Referring now to FIG. 2, Applicant's apparatus, systems, and methods for providing a desalination system using segmented electrodes in a flow-through configuration are illustrated by the system 200. Applicant's system 200 utilizes segmented electrodes having multiple layered cells. The system 200 combines complete, ultra-thin cells into a monolithic and robust framework necessary for desalination applications which yields orders of magnitude faster desalination. Applicant's earlier U.S. patent application Ser. No. 13/405,088 filed Feb. 24, 2012 titled “flow-Through Electrode Capacitive Desalination” was published as U.S. Published Patent Application No. 20112/0273359 on Nov. 1, 2012. U.S. patent application Ser. No. 13/405,088 and U.S. Published Patent Application No. 2012/0273359 are incorporated herein in their entirety for all purposes by this reference.

The capacitive deionization (CDI) system 200 is a process for the capacitive deionization of water. In the system 200 one or more pairs of segmented electrodes 202 and 204 are located so that a flow of feed water, illustrated by the arrows 208a and 208b, flows through the segmented electrodes 202 and 204 and in the direction of the applied electric field. The segmented electrode 202 comprises a layered electrode stack with individual layers 202a, 202b, 202c, etc. The segmented electrode 204 comprises a layered electrode stack with individual layers 204a, 204b, 204c, etc. A porous, solid separator 214 made of a dielectric material to prevent electrical shorts, with thickness less than 20% the sum thickness of the electrodes is located between the layered electrode stack 202 and the layered electrode stack 204.

The capacitive deionization (CDI) system 200 provides one or more monolithic, segmented electrode-separator pairs. The segmented electrodes provide reduction in electrode thickness enable a much faster cycle time, on the order of seconds or less. The monolithic, segmented electrode-separator pairs are produced by modern manufacturing techniques the most promising of which are electrophoretic deposition and tape casting.

Electrophoretic Deposition

In one embodiment the layered electrode stack 202 and the layered electrode stack 204 are fabricated through the use of electrophoretic deposition to create layered thin electrode and separator structures, where each unit cell is of order 100 microns or less. Thus this technique allows for significant increases in throughput over traditional CDI and other water desalination techniques. Electrophoretic deposition (EPD) is a general technique in which colloidal particles of the material of interest are deposited onto a substrate from a suspension using electric fields. EPD allows for precise control over the thickness and composition of each layer and has demonstrated layer thicknesses of ˜10 microns with total part thickness of ˜1 cm. For this particular devices layers of 100 micron thickness of carbon will be separated by layers ˜100 micron of a dielectric material such as silica. The carbon layer can be deposited as carbon or as a carbon precursor that is subsequently post-processed to form carbon. The dielectric layers are deposited directly.

Tape Casting

In another embodiment the layered electrode stack 202 and the layered electrode stack 204 are fabricated through the use of tape casting to create layered thin electrode and separator structures. The first step in tape casting is loading the individual materials of interest into a suitable binder and forming a tape. The carbon tape could be composed of carbon particles dispersed in a polymer binder, or of a polymer monolith that is subsequently post-processed to form carbon. The dielectric tape could contain dielectric material dispersed in a binder. After the tapes are made, they are stacked alternating between the carbon electrode material and dielectric material. External electrical contacts to the electrode layer could be made at this point or in a subsequent step. The stack of tapes are loaded into a die and pressed to compact the tapes. The binder is then removed using thermal or solvent processing and removed from the die.

Method of Operation of the System 200

The layered electrode stack 202 and the layered electrode stack 204 each include pores 216 through which the flow of feed water 206 flows. The micron scale pores 216 allow for fluid flow 206 directly through the segmented electrode 204 while the nano-scale pores 216 provide high surface area for adsorption of ions. An electrical circuit 210 energizes the electrodes 202 and 204 producing an electrical field acting on the feed water 206 producing desalted water 212.

The system 200 is a capacitive deionization system using segmented porous electrodes 202 and 204 in a flow-through configuration. The system 200 uses pump 218 and valve 220 to direct feed water 206 through the segmented electrodes 202 and 204. In one step the feed water 206 is the target salt solution and in another step the feed water 206 is regeneration water. In the first step the target salt solution feed water 206 is pumped into the pores of the electrode conductor 202 and into the pores of electrode conductor 204. The voltage system 210 applies voltage to the electrode conductor 202 and the electrode conductor 204 thereby causing at least a portion of the target salt solution feed water 206 to be adsorbed in the pores of the electrode conductor 202 and into the pores of electrode conductor 204. In the second step the regeneration water feed water 206 is pumped into the pores of the electrode conductor 202 and into the pores of electrode conductor 204. The voltage system 210 voltage is removed from the electrode conductor 202 and the electrode conductor 204 thereby regenerating the electrode conductor 202 and the conductor 204. The flow 208 through the segmented electrodes 202 and 204 is parallel to the direction of the applied field created by the circuit 210, and thus the hydraulic resistance is that of both segmented electrodes 202 and 204 in parallel.

The segmented electrodes 202 and 204 have a network of micron-scale pores allowing for efficient fluidic transport and a large population of sub 50 nm pores to allow for high surface area and capacitance. Activated carbon aerogel materials are an example of this type of pore structure. This type of aerogel can reach an ultra high capacitance of over 100 F/g, and thus is appropriate towards the desalination of sea water.

The segmented electrodes 202 and 204 in a single cell are separated by a porous, solid separator made of a dielectric material to prevent electrical shorts, and less than 100 microns thick. The segmented electrodes may be affixed to a current collector of a metal, such as titanium. Thus, the cell structure (from positive wire to negative wire) is: a positively charged metal sheet current collector, a porous, positively charged electrode, a polymer spacer (<100 microns thick), the negative porous electrode, the negative current collector. A pump directs the target salt solution through the segmented electrode pores, and will generate a pressure of less than order 100 kPa (several orders of magnitude less than required for reverse osmosis desalination of seawater). The desalination cycle will work as follows: the salt containing solution is pushed into a segmented electrode pair segment with no adsorbed ions. A voltage of less than 2 V is applied to remove ions from the water and adsorb them onto the electrode, and to avoid Faradaic reactions. The desalinated volume is pumped out of the segmented electrode segment and replaced with an equal volume of untreated salt water. Then, the voltage is removed from the segmented electrodes and the ions desorb from the segmented electrodes into the untreated water to regenerate the electrode surface, and the brine is then pumped from the cell and replaced with the next batch of water to be desalinated. The system can be operated with many serial and/or parallel cells to allow for high throughput, staged desalination of sea water. Further, alternating desalinated and brine water batches which flow through the electrode system can be separated from each other by several fluids, such as air, other gases or any immiscible liquids. The system can also run with no separating fluid by ensuring the residence time of water in the system is much less than the diffusion time across a water batch.

Further, brine can be recirculated through the system to continue to adsorb charge for several charge/discharge cycles. This method takes advantage of the fact that the solubility of sodium chloride in water is about one order of magnitude higher than the salt concentration of seawater. Thus, brine can be recirculated and used several times to adsorb charge during the regeneration step before the fluid is saturated. This increases the percentage of desalinated water volume to initial water volume to over 80-90%, well above the water recovery rates of reverse osmosis (typically about 40%).

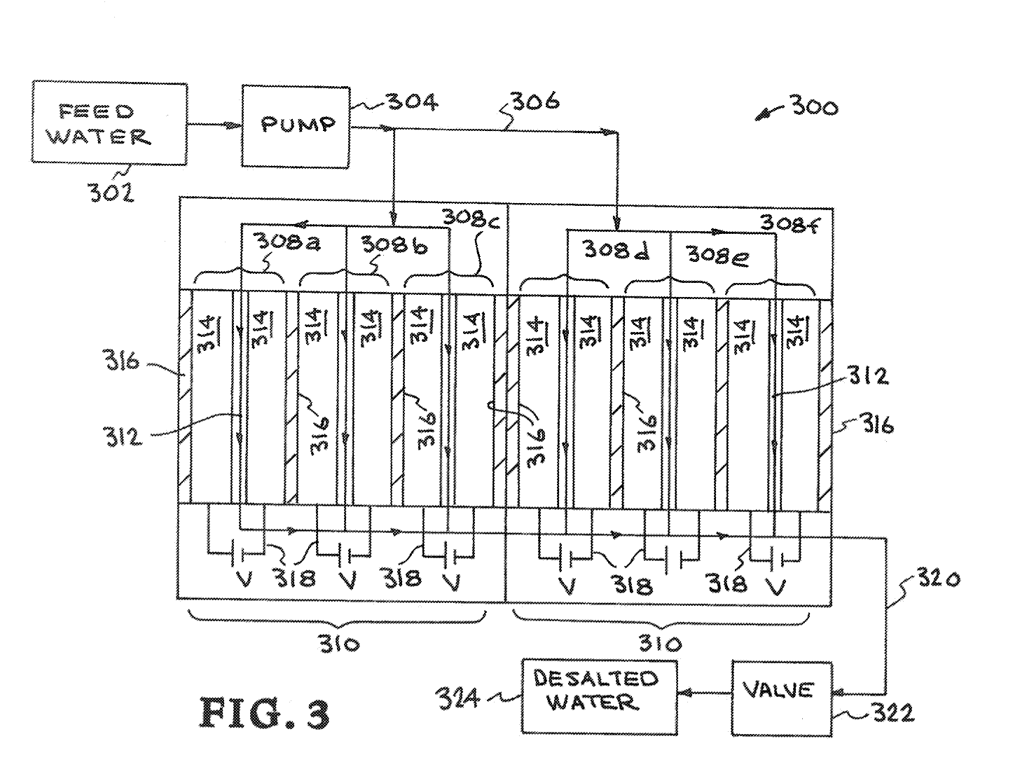

Referring now to FIG. 3, another embodiment of Applicant's apparatus, systems, and methods for providing a desalination system using segmented electrodes are illustrated by the system 300. The capacitive deionization (CDI) system 300 is a process for the capacitive deionization of water. In the system 300 one or more pairs of segmented electrode units 314 are located so that a flow of feed water, illustrated by the arrows 306 and 320, flows into the segmented electrode units 314. The segmented electrode units 314 include layered electrode stacks 308a, 308b, 308c, 308d, 308e, 308f, etc. A porous, solid separator 316 made of a dielectric material to prevent electrical shorts, with thickness less than 20% the sum thickness of the electrodes is located between the layered electrode stacks.

The capacitive deionization (CDI) system 300 provides one or more monolithic, segmented electrode-separator pairs. The segmented electrodes provide reduction in electrode thickness enable a much faster cycle time, on the order of seconds or less. The monolithic, segmented electrode-separator pairs are produced by modern manufacturing techniques the most promising of which are electrophoretic deposition and tape casting.

Method of Operation of the System 300

The system 300 is a system for removing ions from brine water. The system 300 has a feed water source 302 a pump 304 and distribution system 306. The feed water is delivered to units 310. Each of the units 310 is made up of three cells. For example, the first unit 310 is made up of cells 308a, 308b and 308c. The three cells contained in the first unit 310 are arranged in parallel. A typical cell such as cell 308a is made up of two porous, conductive electrodes 314 separated by a porous dielectric separator 316. A power source 318 is shown connected to the two porous conductive electrodes 314. As shown, the cells 308a-f are greatly enlarged for ease of illustration. In reality the thickness of the cells would be approximately 100 microns. As shown in FIG. 3 there are two units 310 shown in parallel and separated by a porous dielectric member 316. Any number of units 310 may he connected in series or in parallel. The system 300 operates to remove salt ions and leave pure water that exits the system 300 by way of collection system 320 through valve 3222 and enters desalted water tank 324.

The layered electrode stacks 310 include pores into which the flow of feed water flows. The micron scale pores allow for fluid flow directly through the segmented electrodes 308a-f while the nano-scale pores provide high surface area for adsorption of ions. The electrical circuits 318 energize the electrodes producing an electrical field acting on the feed water producing desalted water 324. The desalination cycle works as follows: the feed water salt solution is pushed into the segmented electrode 314. A voltage is applied to remove ions from the water and adsorb them onto the electrode, and to avoid Faradaic reactions. The desalinated volume is pumped out of the segmented electrode 314 and replaced with an equal volume of untreated salt water. Then, the voltage is removed from the segmented electrodes 314 and the ions desorb from the segmented electrodes 314 into the untreated water to regenerate the electrode surface, and the brine is then pumped from the cell and replaced with the next batch of water to be desalinated.

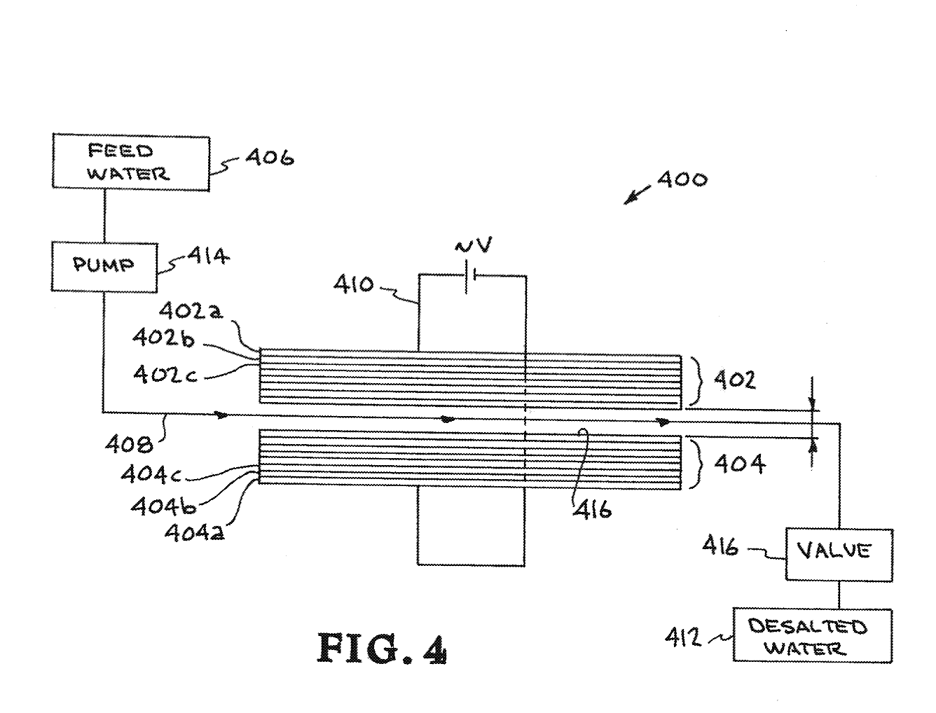

Referring now to FIG. 4, Applicant's apparatus, systems, and methods for providing a desalination system using segmented electrodes in a flow-between configuration are illustrated by the system 400. Feed water from a feed water source 406 is directed through the gap 414 between the first segmented electrode 402 and the second segmented electrode 404. A permeable separator layer can be positioned in the gap 414 between the electrodes 402 and 404 to prevent electrical shorts between the electrodes. As illustrated in FIG. 4, the flow of feed water enters the gap 414 and travels in a direction perpendicular to the applied electric field. The flow of feed water in the gap 414 is illustrated by the arrow 408. The feed water is directed from feed water source 406 into the gap 414 and into the first segmented electrode 402 and the second segmented electrode 404 where the electrical field provides desalting and into the desalted water unit 412.

Applicant's system 400 utilizes segmented electrodes having multiple layered cells. The system 400 combines complete, ultra-thin cells into a monolithic and robust framework necessary for desalination applications which yields orders of magnitude faster desalination.

The capacitive deionization (CDI) system 400 is a process for the capacitive deionization of water. In the system 400 one or more pairs of segmented electrodes 402 and 404 are located so that a flow of feed water, illustrated by the arrows 408a and 408b, flows into the segmented electrodes 402 and 404. The segmented electrode 402 comprises a layered electrode stack with individual layers 402a, 402b, 402c, etc. The segmented electrode 404 comprises a layered electrode stack with individual layers 404a, 404b, 404c, etc.

The capacitive deionization (CDI) system. 400 provides one or more monolithic, segmented electrode-separator pairs. The segmented electrodes provide reduction in electrode thickness enable a much faster cycle time, on the order of seconds or less. The monolithic, segmented electrode-separator pairs are produced by modern manufacturing techniques the most promising of which are electrophoretic deposition and tape casting.

Electrophoretic Deposition

In one embodiment the layered electrode stack 402 and the layered electrode stack 404 are fabricated through the use of electrophoretic deposition to create layered thin electrode and separator structures, where each unit cell is of order 100 microns or less. Thus this technique allows for significant increases in throughput over traditional CDI and other water desalination techniques. Electrophoretic deposition (EPD) is a general technique in which colloidal particles of the material of interest are deposited onto a substrate from a suspension using electric fields. EPD allows for precise control over the thickness and composition of each layer and has demonstrated layer thicknesses of ˜10 microns with total part thickness of ˜1 cm. For this particular device, layers of 100 micron thickness of carbon will be separated by layers ˜100 micron of a dielectric material such as silica. The carbon layer can be deposited as carbon or as a carbon precursor that is subsequently post-processed to form carbon. The dielectric layers are deposited directly.

Tape Casting

In another embodiment the layered electrode stack 402 and the layered electrode stack 404 are fabricated through the use of tape casting to create layered thin electrode and, separator structures. The first step in tape casting is loading the individual materials of interest into a suitable binder and forming a tape. The carbon tape could be composed of carbon particles dispersed in a polymer binder, or of a polymer monolith that is subsequently post processed to form carbon. The dielectric tape could contain dielectric material dispersed in a binder. After the tapes are made, they are stacked alternating between the carbon electrode material and dielectric material. External electrical contacts to the electrode layer could be made at this point or in a subsequent step. The stack of tapes are loaded into a die and pressed to compact the tapes. The binder is then removed using thermal or solvent processing and removed from the die.

Method of Operation of the System 400

The layered electrode stack 402 and the layered electrode stack 404 each include pores 416 into which the flow of feed water 406 flows. The micron scale pores 416 allow for fluid flow 406 directly into the segmented electrodes 402 and 404 while the nano-scale pores 416 provide high surface area for adsorption of ions. An electrical circuit 410 energizes the electrodes 402 and 404 producing an electrical field acting on the feed water 406 producing desalted water 412.

The system 400 is a capacitive deionization system using segmented porous electrodes 412 and 404 in a flow-between configuration. The feed water 406 flows into the segmented electrodes 402 and 404. The segmented electrodes used have a network of micron-scale pores allowing for efficient fluidic transport and a large population of sub 50 nm pores to allow for high surface area and capacitance. Activated carbon aerogel materials are an example of this type of pore structure. This type of aerogel can reach an ultra high capacitance of over 100 F/g, and thus is appropriate towards the desalination of sea water.

A pump directs the feed water salt solution into the segmented electrode pores. The desalination cycle will work as follows: the feed water salt solution is pushed into a segmented electrode pair segment with no adsorbed ions. A voltage of less than 2 V is applied to remove ions from the water and adsorb them onto the electrode, and to avoid Faradaic reactions. The desalinated volume is pumped out of the segmented electrode segment and replaced with an equal volume of untreated salt water. Then, the voltage is removed from the segmented electrodes and the ions desorb from the segmented electrodes into the untreated water to regenerate the electrode surface, and the brine is then pumped from the cell and replaced with the next batch of water to be desalinated.

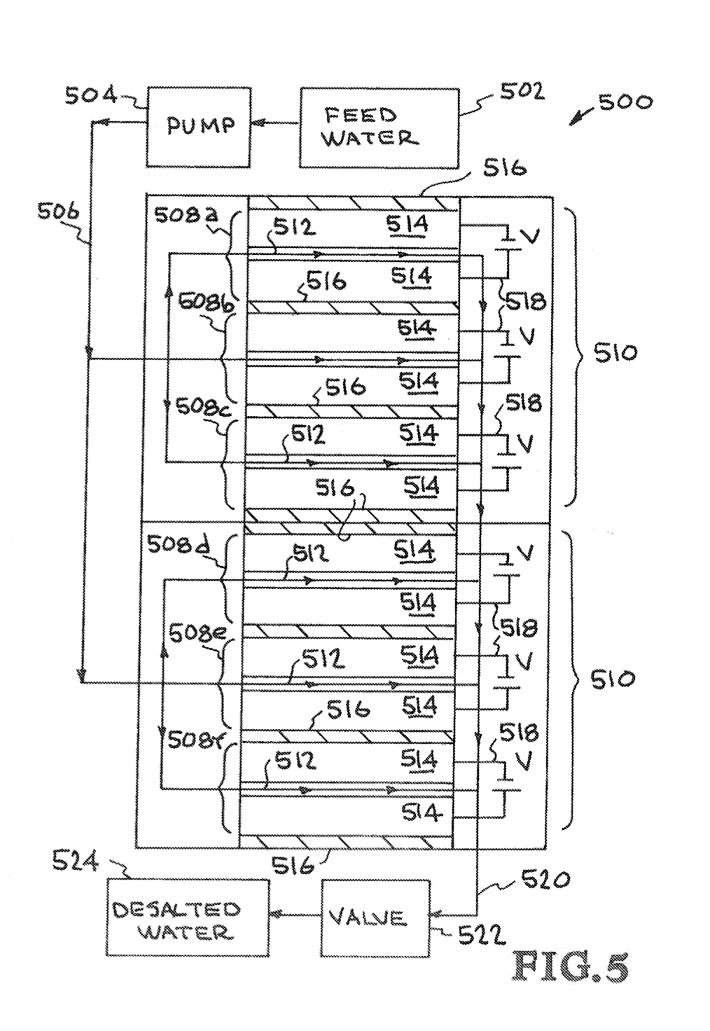

Referring now to FIG. 5, another embodiment of Applicant's apparatus, systems, and methods for providing a desalination system using segmented electrodes in a flow-between configuration are illustrated by the system 500. Feed water from a feed water source 502 is directed by pump 504 through a gap 512 between two segmented electrodes 514 that form an electrode pair. In one or more embodiments a permeable separator layer cart be positioned in the gap 512 between the electrodes 514 to prevent electrical shorts between the electrodes. As illustrated in FIG. 5, the flow of feed water enters the gap 512 and travels in a direction perpendicular to the applied electric field. The flow of feed water in the gap 512 is illustrated by the arrow 506. The feed water is directed from feed water source 502 into the gap 512 and into the segmented electrodes 514 where the electrical field provides desalting and into the desalted water unit 524.

Applicant's system 500 utilizes segmented electrodes having multiple layered cells. The system 500 combines complete, ultra-thin cells into a monolithic and robust framework necessary for desalination applications which yields orders of magnitude faster desalination.

The capacitive deionization (CDI) system 500 is a process for the capacitive deionization of water. In the system 500 one or more pairs of segmented electrodes 514 are located so that a flow of feed water, illustrated by the arrow 506, flows into the electrodes 514. The segmented electrodes 514 are shown as individual electrode pairs 508a, 508b, 508c, 508d, 508e, 508f, etc. Each electrode pair is made of an electrode having a layered electrode stack with individual layers. The individual layers are fabricated through the use of additive manufacturing with electrophoretic deposition or tape casting to create layered thin electrode and separator structures.

The capacitive deionization (CDI) system 500 provides one or more segmented electrode-separator pairs. The segmented electrodes provide reduction in electrode thickness enable a much faster cycle time, on the order of seconds or less. The monolithic, segmented electrode-separator pairs are produced by modern manufacturing techniques the most promising of which are electrophoretic deposition and tape casting.

The capacitive deionization (CDI) system 500 employs a first unit 510 containing multiple cells 508a, 508b and 508c connected in parallel, each with a voltage source 518. A second unit 510 employs cells 508d, 508e and 508f. The units 510 are shown located on opposite sides of partition 516. As illustrated, multiple cells with multiple electrodes are located on opposite side of the partition 516 versus the single electrode on either side as shown in FIG. 4. The feed water 502 is pumped through the gaps 512 and into the electrodes 514 wherein the action of the cells (any number can be used) removes, in this case salt ions. Purified water will exit the system and proceed through valve 522 to be collected as desalted water 524. The desalination cycle works as follows: the feed water salt solution is pushed into the segmented electrodes with no adsorbed ions. A voltage of is applied to remove ions from the water and adsorb them onto the electrode and to avoid Faradaic reactions. The desalinated volume is pumped out of the electrodes and replaced with an equal volume of untreated salt water. Then, the voltage is removed from the electrodes and the ions desorb from the electrodes into the untreated water to regenerate the electrode surface, and the brine is then pumped from the cell and replaced with the next batch of water to be desalinated.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. A capacitive desalination apparatus, comprising:
a target solution containing salt;
regeneration water;
a first electrode conductor unit made of a first multiplicity of individual layers having first pores;
a second electrode conductor unit made of a second multiplicity of individual layers having second pores;
a voltage system for applying a voltage to said first electrode conductor unit and said second electrode conductor unit; and
a pump for
in one step pumping said regeneration water into said first pores of said first multiplicity of individual layers and said second pores of said second multiplicity of individual layers while said voltage system does not apply a voltage to said first electrode conductor unit and said second electrode conductor unit thereby regenerating said first electrode conductor unit and said second electrode conductor unit, and
in another step pumping said target salt solution into said first pores of said first multiplicity of individual layers and into said second multiplicity of individual layers while said voltage system applies voltage to said first electrode conductor unit and said second electrode conductor unit thereby causing at least a portion of said salt to be adsorbed in said first pores and said second pores providing desalination of said target salt solution.

2. The capacitive desalination apparatus of claim 1 wherein said first electrode conductor unit includes a multiple of first layered electrode stacks and wherein said second electrode conductor unit includes a multiple of second layered electrode stacks.

3. The capacitive desalination apparatus of claim 1 wherein said first electrode conductor unit and said second electrode conductor unit are positioned so that said pump pumps said target salt solution through said first electrode conductor unit and said second electrode conductor unit.

4. The capacitive desalination apparatus of claim 1 wherein said first electrode conductor unit and said second electrode conductor unit are positioned so that said pump pumps said target salt solution between said first electrode conductor unit and said second electrode conductor unit and into said first electrode conductor unit and said second electrode conductor unit.

5. A flow through capacitive desalination apparatus, comprising:
a target solution containing salt;
regeneration water;
a first electrode conductor unit made of a first multiplicity of individual layers having first pores;
a second electrode conductor unit made of a second multiplicity of individual layers having second pores, wherein said first electrode conductor unit and said second electrode conductor unit are aligned;
a voltage system for applying a voltage to said first electrode conductor unit and said second electrode conductor unit; and
a pump for
in one step pumping said target salt solution through said aligned first electrode conductor unit and said second electrode conductor unit, wherein said target salt solution is pumped into said first pores of said first multiplicity of individual layers and into said second pores of said first multiplicity of individual layers while said voltage system applies voltage to said first electrode conductor unit and said second electrode conductor unit thereby causing at least a portion of said salt to be adsorbed in said first pores and said second pores providing desalination of said target salt solution, and
in another step pumping said regeneration water through said aligned first electrode conductor unit and said second electrode conductor unit, wherein said regeneration water is pumped into said first pores of said first multiplicity of individual layers and into said second pores of said first multiplicity of individual layers while said voltage system does not apply a voltage to said first electrode conductor unit and said second electrode conductor unit thereby regenerating said first electrode conductor unit and said second electrode conductor unit.

6. The flow through capacitive desalination apparatus of claim 5 wherein said first electrode conductor unit includes a multiple of first layered electrode stacks and wherein said second electrode conductor unit includes a multiple of second layered electrode stacks.

7. The now through capacitive desalination apparatus of claim 5, further comprising a permeable non electrical conduction separator positioned between said aligned first electrode conductor unit and said second electrode conductor unit.

8. A flow between capacitive desalination apparatus, comprising:
a target solution containing salt;
regeneration water;
a first electrode conductor unit made of a first multiplicity of individual layers having first pores;
a second electrode conductor unit made of a second multiplicity of individual layers having second pores, wherein said first electrode conductor unit and said second electrode conductor unit are positioned adjacent each other with a gap between said first electrode conductor unit and said second electrode conductor unit;
a voltage system for applying a voltage to said first electrode conductor unit and said second electrode conductor unit; and
a pump for
in one step pumping said target salt solution into said gap between said first electrode conductor unit and said second electrode conductor unit and into said first pores of said first multiplicity of individual layers and into said second pores of said second multiplicity of individual layers while said voltage system applies voltage to said first electrode conductor unit and said second electrode conductor unit thereby causing at least a portion of said salt to be adsorbed in said first pores and said second pores providing desalination of said target salt solution, and
in another step pumping said regeneration water into said gap between said first electrode conductor unit and said second electrode conductor unit and into said first pores of said first multiplicity of individual layers and into said second pores of said second multiplicity of individual layers while said voltage system does not apply a voltage to said first electrode conductor unit and said second electrode conductor unit thereby regenerating said first electrode conductor unit and said second electrode conductor unit.

9. The flow between capacitive desalination apparatus of claim 8, wherein said first electrode conductor unit includes a multiple of first layered electrode stacks and wherein said second electrode conductor unit includes a multiple of second layered electrode stacks.

10. The flow between capacitive desalination apparatus of claim 8, further comprising a permeable non electrical conduction separator positioned between said first electrode conductor unit and said second electrode conductor unit in said gap between said first electrode conductor unit and said second electrode conductor unit.

11. A method of capacitive desalination, comprising the steps of:
providing a target solution containing salt;
providing regeneration water;
providing a first electrode conductor unit made of a first multiplicity of individual layers having first pores;
providing a second electrode conductor unit made of a second multiplicity of individual layers having second pores;
aligning said first electrode conductor unit with said second electrode conductor unit;
providing a voltage system for applying a voltage to said first electrode conductor unit and said second electrode conductor unit;
in one step pumping said target salt solution through said aligned first electrode conductor unit and said second electrode conductor unit and into said first pores of said first multiplicity of individual layers and into said second pores of said second multiplicity of individual layers while said voltage system applies voltage to said first electrode conductor unit and said second electrode conductor unit thereby causing at least a portion of said salt to be adsorbed in said first pores and said second pores providing desalination of said target salt solution, and
in another step pumping said regeneration water through said aligned first electrode conductor unit and said second electrode conductor unit and into said first pores of said first multiplicity of individual layers and into said second pores of said second multiplicity of individual layers while said voltage system does not apply a voltage to said first electrode conductor unit and said second electrode conductor unit thereby regenerating said first electrode conductor and said second electrode conductor unit.

12. A method of capacitive desalination, comprising the steps of:
providing a target solution, containing salt;
providing regeneration water;
providing a first electrode conductor unit made of a first multiplicity of individual layers having first pores;
providing a second electrode conductor unit made of a second multiplicity of individual layers having second pores;
positioning said first electrode conductor unit and said second electrode conductor unit adjacent each other with a gap between said first electrode conductor unit and said second electrode conductor unit;
providing a voltage system for applying a voltage to said first electrode conductor unit and said second electrode conductor unit; and
in one step pumping said target salt solution into said gab between said first electrode conductor unit and said second electrode conductor unit and into said first pores of said first multiplicity of individual layers and into said second pores of said first multiplicity of individual layers while said voltage system applies voltage to said first electrode conductor unit and said second electrode conductor unit thereby causing at least a portion of said salt to be adsorbed in said first pores and said second pores providing desalination of said target salt solution, and
in another step pumping said regeneration water into said gab between said first electrode conductor unit and said second electrode conductor unit and into said first pores of said first multiplicity of individual layers and into said second pores of said second multiplicity of individual layers while said voltage system does not apply a voltage to said first electrode conductor unit and said second electrode conductor unit thereby regenerating said first electrode conductor and said second electrode conductor.

13. A method of fabricating a capacitive desalination system using regeneration water and a target salt solution, comprising the steps of:
fabricating a first electrode conductor unit made of a first multiplicity of individual layers having first pores;
fabricating a second electrode conductor unit made of a second multiplicity of individual layers having second pores;
positioning said first electrode conductor unit adjacent said second electrode conductor unit;
connecting a voltage system to said first electrode conductor unit and said second electrode conductor unit; and
connecting a pumping system to said first electrode conductor unit and said second electrode conductor unit, wherein
in one operation the regeneration water is pumped into said first pores of said first multiplicity of individual layers and said second pores of said second multiplicity of individual layers while said voltage system does not apply a voltage to said first electrode conductor unit and said second electrode conductor unit thereby regenerating said first electrode conductor unit and said second electrode conductor unit, and
in another operation pumping the target salt solution into said first pores of said first multiplicity of individual layers and into said second multiplicity of individual layers while said voltage system applies voltage to said first electrode conductor unit and said second electrode conductor unit thereby causing at least a portion of said salt to be adsorbed in said first pores and said second pores providing desalination of said target salt solution.

14. The method of fabricating a capacitive desalination system using regeneration water and a target salt solution of claim 13 wherein said step of fabricating a first electrode conductor unit includes fabricating a multiple of first layered electrode stacks and wherein said step of fabricating a second electrode conductor unit includes fabricating a multiple of second layered electrode stacks.

15. A method of fabricating a flow through capacitive desalination system using regeneration water and a target salt solution, comprising the steps of:
fabricating a first electrode conductor unit made of a first multiplicity of individual layers having first pores;
fabricating a second electrode conductor unit made of a second multiplicity of individual layers having second pores;
positioning said first electrode conductor unit adjacent said second electrode conductor unit with a multiplicity of flow channels in said first electrode conductor unit and said second electrode conductor unit;
connecting a voltage system to said first electrode conductor unit and said second electrode conductor unit; and
connecting a pumping system to said first electrode conductor unit and said second electrode conductor unit, wherein
in one operation the regeneration water is pumped into said first pores of said first multiplicity of individual layers and said second pores of said second multiplicity of individual layers while said voltage system does not apply a voltage to said first electrode conductor unit and said second electrode conductor unit thereby regenerating said first electrode conductor unit and said second electrode conductor unit, and
in another operation pumping the target salt solution into said first pores of said first multiplicity of individual layers and into said second multiplicity of individual layers while said voltage system applies voltage to said first electrode conductor unit and said second electrode conductor unit thereby causing at least a portion of said salt to he adsorbed in said first pores and said second pores providing desalination of said target salt solution.

16. The method of fabricating a flow through capacitive desalination system using regeneration water and a target salt solution of claim 15 wherein said step of fabricating a first electrode conductor unit includes fabricating a multiple of first layered electrode stacks and wherein said step of fabricating a second electrode conductor unit includes fabricating a multiple of second layered electrode stacks.

17. A method of fabricating a flow between capacitive desalination system using regeneration water and a target salt solution, comprising the steps of:
fabricating a first electrode conductor unit made of a first multiplicity of individual layers having first pores;
fabricating a second electrode conductor unit made of a second multiplicity of individual layers having second pores,;
positioning said first electrode conductor unit adjacent said second electrode conductor unit with a multiplicity of flow channels between said first electrode conductor unit and said second electrode conductor unit;
connecting a voltage system to said first electrode conductor unit and said second electrode conductor unit; and
connecting a pumping system to said first electrode conductor unit and said second electrode conductor unit, wherein
in one operation the regeneration water is pumped into said first pores of said first multiplicity of individual layers and said second pores of said second multiplicity of individual layers while said voltage system does not apply a voltage to said first electrode conductor unit and said second electrode conductor unit thereby regenerating said first electrode conductor unit and said second electrode conductor unit, and
in another operation pumping the target salt solution into said first pores of said first multiplicity of individual layers and into said second multiplicity of individual layers while said voltage system applies voltage to said first electrode conductor unit and said second electrode conductor unit thereby causing at least a portion of said salt to be adsorbed in said first pores and said second pores providing desalination of said target salt solution.

18. The method of fabricating a flow between capacitive desalination system using regeneration water and a target salt solution of claim 17 wherein said step of fabricating a first electrode conductor unit includes fabricating a multiple of first layered electrode stacks and wherein said step of fabricating a second electrode conductor unit includes fabricating a multiple of second layered electrode stacks.
